(19) United States
(12) Patent Application Publication
(10) Pub. No.: US 2024/0134928 A1
(43) Pub. Date: Apr. 25, 2024

(54) DATA PROCESSING APPARATUS, CONVOLUTION PROCESSING APPARATUS, DATA PROCESSING METHOD, AND NON-TRANSITORY COMPUTER READABLE STORAGE MEDIUM

(71) Applicant: MegaChips Corporation, Osaka (JP)

(72) Inventor: Mahito MATSUMOTO, Osaka (JP)

(73) Assignee: MegaChips Corporation, Osaka (JP)

(21) Appl. No.: 18/377,437

(22) Filed: Oct. 6, 2023

(30) Foreign Application Priority Data
Oct. 13, 2022 (JP) 2022-164890

(51) Int. Cl. G06F 17/15; G06F 17/16

(52) U.S. Cl. CPC G06F 17/153; G06F 17/16

(57) ABSTRACT

Provide is data processing apparatus that performs highly accurate data processing accompanying vector decomposition processing, quantization processing, convolution processing and the like for any distribution of data. The data processing apparatus obtains a plurality of local solutions in the vector decomposition processing, selects a plurality of data adjustment processes performed before the quantization processing for each of the obtained local solutions of the vector decomposition processing, obtains the accuracy of the convolution processing, and then determines a local solution of the vector decomposition processing with highest accuracy and the data adjustment processing, with highest accuracy, performed before the quantization.

### CROSS-REFERENCE TO RELATED APPLICATION

This application claims priority to Japanese Patent Application No. 2022-164890 filed on Oct. 13, 2022, the entire disclosure of which is hereby incorporated herein by reference.

### BACKGROUND OF THE INVENTION

### Field of the Invention

The present disclosure relates to data processing technology, and in particular relates to data processing with vector decomposition processing, quantization processing, and convolution processing.

### Description of the Background Art

In recent years, techniques using neural network models achieving various applications with high accuracy have been attracting attention. Such techniques using neural network models train neural network models using training data to obtain trained models, and performs prediction processing (inference processing) using the obtained trained models. This allows the techniques using neural network models to provide various applications with high accuracy.

A neural network model using with such techniques includes an input layer, a plurality of hidden layers, and an output layer. Increasing the number of the hidden layers (deepening the hidden layers) in the neural network allows for obtaining a model (e.g., a model for deep learning (a deep neural network model)) capable of performing highly accurate prediction (inference) for complex events.

In general, the neural network model performs processing of updating parameters (processing of updating weighted coefficients of nodes included in each layer of the neural network) in training so as to decrease a difference between supervised data and data outputted from the neural network model. In such processing, the neural network model performs processing of updating parameters using backpropagation algorithms; if the neural network model includes deep layers (if the number of hidden layers is large), gradients required for backpropagation becomes so small that training processing does not proceed properly.

To cope with this, technique disclosed in Patent Document 1 (Patent Document 1: US Application Publication No. 2016/217368) includes batch normalization layer(s) in the hidden layers to prevent the gradients from vanishing during backpropagation. In other words, the technique disclosed in Patent Document 1 provides a structure in which the batch normalization layer performs normalization (standardization) so that output data from the hidden layer at the front of the batch normalization layer is converted to data whose average is “0” and its variance is “1” for each identical channel of a mini-batch, thus preventing the gradients from vanishing during backpropagation and allowing for properly performing training. In addition, performing batch normalization processing (providing batch normalization layer(s)) causes data, which is to be processed in the hidden layer(s), to be data having a moderately distributed distribution, thereby allowing for preventing overfitting.

However, with the above conventional technique, when output values from the hidden layer(s) include outlier(s), values obtained by normalizing the output values are concentrated in a narrow range near the average value “0”; thus, the distribution of values obtained by normalizing the output values from the hidden layer(s) cannot be a moderately distributed distribution. For example, if quantization processing is performed on data included in the above-described skewed distribution (distribution in which the values obtained by normalizing the output values from the hidden layer(s) are concentrated in a narrow range near the average value “0”), values after quantization processing are concentrated in a narrow range near a certain value, and thus training processing does not properly progress in the neural network model. This makes it difficult to obtain a trained model that properly performs prediction processing (inference processing).

In recent years, after decomposing weight coefficients into coefficient vector(s) and basis vector(s) (performing vector decomposition processing) and performing quantization processing on input data into the hidden layer(s), convolution processing on the weight coefficients and the quantized data obtained by the vector decomposition processing or the like is often performed. When data with outlier(s) inputted into the hidden layer that performs the above-described processing, normalization processing is performed on the data, and then vector decomposition processing, quantization processing and convolution processing are performed, data after quantization processing has a skewed distribution, resulting in not progressing properly in the neural network model having the hidden layer(s); as a result, this makes it difficult to obtain a trained model that properly performs prediction processing (inference processing).

In view of the above problems, it is an object of the present invention to provide data processing apparatus, quantization processing apparatus, data processing method, and program that perform highly accurate data processing accompanying vector decomposition processing, quantization processing, convolution processing and the like for any distribution of data.

### SUMMARY

To solve the above problems, a first aspect of the present invention provides a data processing apparatus for performing convolution processing on matrix data including a plurality of elements using a weight coefficient matrix, including vector decomposition processing circuitry, quantization processing circuitry, convolution processing circuitry, and evaluation circuitry.

The vector decomposition processing circuitry performs vector decomposition processing of decomposing the weight coefficient matrix into a basis matrix whose elements are basis values and a real number coefficient vector whose elements are real numbers.

The quantization processing circuitry is capable of performing multiple types of data adjustment processing, selects one of the multiple types of data adjustment processing, performs the selected data adjustment processing on the matrix data to obtain data after data adjustment processing, and performs quantization processing on the obtained data after data adjustment processing to obtain data after quantization processing.

The convolution processing circuitry performs convolution processing on the data after quantization processing using the basis matrix and the real number coefficient vector that have been obtained in the vector decomposition by the vector decomposition processing circuitry, thereby obtaining data after convolution processing as data after vector decomposition and convolution processing.

The evaluation circuitry obtains an evaluation result based on a correct matrix data, which is data obtained by convolution processing on the matrix data using the weight coefficient matrix, and the data after vector decomposition and convolution processing.

### BRIEF DESCRIPTION OF THE DRAWINGS

FIG. 1 is a schematic configuration diagram of a data processing apparatus 100 according to a first embodiment.

FIG. 2 is a diagram for explaining data for optimization processing in the data processing apparatus 100.

FIG. 3 is a schematic configuration diagram of the data processing apparatus 100 and is a diagram for explaining an operation when optimization processing is performed.

FIG. 4 is a sequence diagram of optimization processing (timing chart) performed in the data processing apparatus 100.

FIG. 5 is a diagram for explaining data range adjustment processing.

FIG. 6 is a schematic configuration diagram of the data processing apparatus 100 and is a diagram for explaining an operation when data processing (prediction processing) is performed.

FIG. 7 is a diagram showing a CPU bus configuration.

### DESCRIPTION OF THE PREFERRED EMBODIMENTS

### First Embodiment

A first embodiment will be described below with reference to the drawings.

### 1.1: Configuration of Data Processing Apparatus

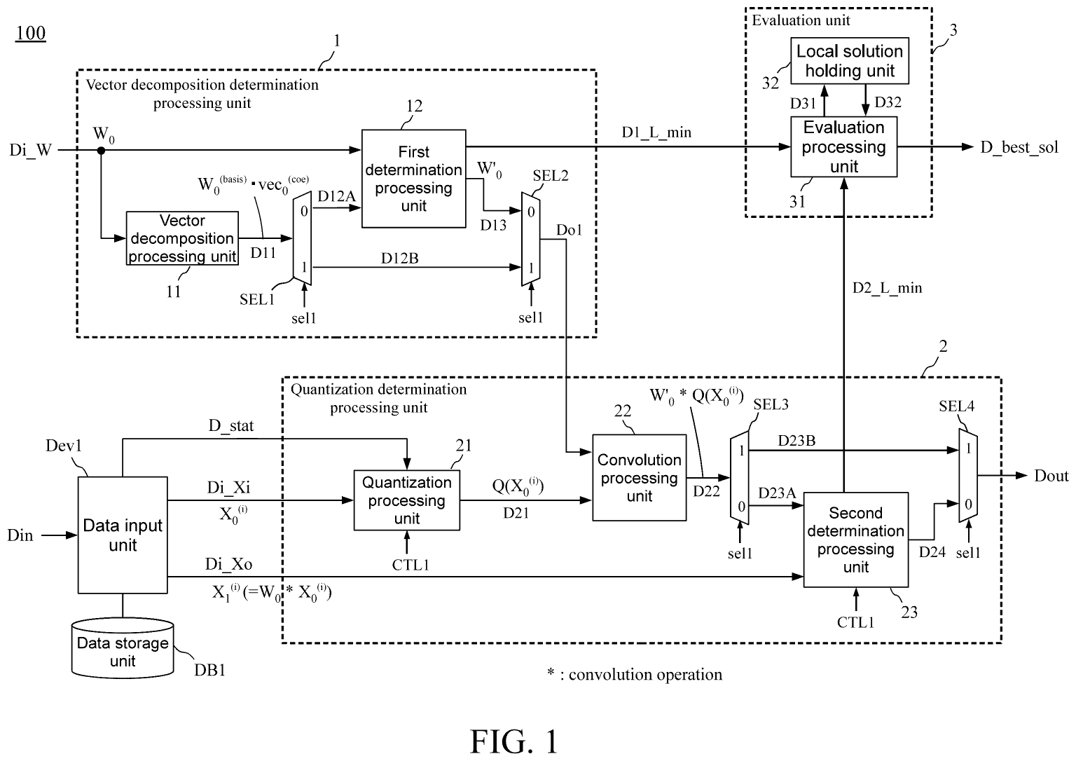

FIG. 1 is a schematic configuration diagram of a data processing apparatus 100 according to a first embodiment.

As shown FIG. 1, the data processing apparatus 100 includes a vector decomposition determination processing unit 1, a data input unit Dev1, a data storage unit DB1, a quantization determination processing unit 2, and an evaluation unit 3.

As shown FIG. 1, the vector decomposition determination processing unit 1 includes a vector decomposition processing unit 11, a first selector SEL1, a first determination processing unit 12, and a second selector SEL2.

The vector decomposition processing unit 11 receives data Di_W including a weight coefficient matrix W₀, performs vector decomposition processing on the data Di_W, and then transmits data including the result of the processing as data D11 to the first selector SEL1. Note that the result obtained by vector-decomposing the weight coefficient matrix W₀ is expressed as W₀^{(basis)}·vec₀^{(COE)}. vec₀^{(COE)} is a coefficient vector; W₀^{(basis)} is a basis matrix (a matrix represented by using a given basis).

The first selector SEL1 is a one-input two-output selector, and receives the data D11 transmitted from the vector decomposition processing unit 11. Also, the first selector SEL1 receives a selection signal sel1 transmitted from a control unit (not shown) that controls each functional unit of the data processing apparatus 100. In accordance with the selection signal sel1, the first selector SEL1 transmits the received data D11 to the first determination processing unit 12 or the second selector SEL2. Note that data transmitted from the first selector SEL1 to the first determination processing unit 12 is referred to as data D12A (=D11); data transmitted from the first selector SEL1 to the second selector SEL2 is referred to as data D12B (=D11).

The first determination processing unit 12 receives the data Di_W including the weight coefficient matrix W₀ and the data D12A transmitted from the first selector SEL1. The first determination processing unit 12 performs first determination processing using the data Di_W and the data D12A (described in detail later), and then transmits data obtained by the processing as data D13 to the second selector SEL2. Also, the first determination processing unit 12 transmits data including the resultant data of the first determination processing as data D1_L_min to the evaluation unit 3. Note that the weight matrix obtained by the first determination processing is referred to as W′₀.

The second selector SEL2 is a two-input one-output selector, and receives the data D13 transmitted from the first determination processing unit 12 and the data D12B transmitted from the first selector SEL1. Also, the second selector SEL2 receives the selection signal sel1 transmitted from the control unit (not shown) that controls each functional unit of the data processing apparatus 100. In accordance with the selection signal sel1, the second selector SEL2 selects the data D13 or the data 12B, and then transmits the selected data to the quantization determination processing unit 2 as data Do1.

The data input unit Dev1 is connected with the data storage unit DB1, and transmits a read instruction to the data storage unit DB1 to read out data stored in the data storage unit DB1. Also, the data input unit Dev1 is capable of receiving data Din that is inputted from the outside. The data input unit Dev1 obtains statistical data of the read-out data from the data storage unit DB1, and then transmits data including the obtained statistical data as data D_stat to the quantization processing unit 21. Also, the data input unit Dev1 transmits data including input data X₀⁽ⁱ⁾ (input data for quantization processing) of the read-out features from the data storage unit DB1 to the quantization processing unit 21 as data Di_Xi. Also, the data input unit Dev1 transmits data including output data X₁⁽ⁱ⁾ (output data for quantization processing) of the read-out features from the data storage unit DB1 to the second determination processing unit 23 as data Di_Xo.

The data storage unit DB1 is connected with the data input unit Dev1; in accordance with an instruction from the data input unit Dev1, it writes data to the data storage unit DB1, and/or reads out data that has been stored in the data storage unit DB1, and then transmits it to the data input unit Dev1. The data storage unit DB1 is provided by using a database, for example.

As shown in FIG. 1, the quantization determination processing unit 2 includes a quantization processing unit 21, a convolution processing unit 22, a third selector SEL3, a second determination processing unit 23, and a fourth selector SEL4.

The quantization processing unit 21 receives the data Di_Xi and D_stat transmitted from the data input unit Dev1. The quantization processing unit 21 also receives a control signal CTL1 that is transmitted from the control unit (not shown) controlling each functional unit of the data processing apparatus 100, and indicates a method providing data range adjustment processing. Using the method indicated by the control signal CTL1, the quantization processing unit 21 performs processing that adjusts a range of data (data range adjustment processing) on the data Di_Xi based on the data D_stat. The quantization processing unit 21 performs quantization processing on data after data range adjustment processing. The quantization processing unit 21 then transmits the data after data range adjustment processing to the convolution processing unit 22 as data D21. Note that data (matrix) obtained by performing data range adjustment processing and quantization processing on the input data X₀ (matrix X₀⁽ⁱ⁾) of features included in the input data Di_Xi is referred to as Q(X₀⁽ⁱ⁾). Q( ) represents a function corresponding to the data range adjustment processing and the quantization processing.

The convolution processing unit 22 receives the data Do1 transmitted from the vector decomposition determination processing unit 1 and the data D21 transmitted from the quantization processing unit 21. The convolution processing unit 22 performs convolution processing on the data Do1 and the data D21 and then transmits data after convolution processing to the third selector SEL3 as data D22. Note that data obtained by performing convolution processing on W′₀ and Q(X₀⁽ⁱ⁾) is referred to as W′*Q(X₀⁽ⁱ⁾) (“*” represents convolution processing (convolution operation)).

The third selector SEL3 is a one-input two-output selector, and receives the data D22 transmitted from the convolution processing unit 22. Also, the third selector SEL3 receives a selection signal sel1 transmitted from the control unit (not shown) that controls each functional unit of the data processing apparatus 100. In accordance with the selection signal sel1, the third selector SEL3 transmits the received data D22 to the second determination processing unit 23 or the fourth selector SEL4. Note that data transmitted from the third selector SEL3 to the second determination processing unit 23 is referred to as data D23A (=D22); data transmitted from the third selector SEL3 to the fourth selector SEL4 is referred to as data D23B (=D22).

The second determination processing unit 23 receives the data Di_Xo including the output data matrix X₁⁽ⁱ⁾, the data D23A transmitted from the third selector SEL3, and the control signal CTL1 transmitted from the control unit (not shown). The second determination processing unit 23 performs second determination processing using the data Di_Xo and the data D23A, and transmits data obtained after the processing to the fourth selector SEL4 as data D24. Also, the second determination processing unit 23 transmits data including the result of the second determination processing to the evaluation unit 3 as data D2_L_min.

The fourth selector SEL4 is a two-input one-output selector, and receives the data D24 transmitted from the second determination processing unit 23 and the data D23B transmitted from the third selector SEL3. Also, the fourth selector SEL4 receives a selection signal sel1 transmitted from the control unit (not shown) that controls each functional unit of the data processing apparatus 100. In accordance with the selection signal sel1, the fourth selector SEL4 selects the data D24 or the data 23B, and then transmits the selected data as data Dout.

As shown in FIG. 1, the evaluation unit 3 includes an evaluation processing unit 31 and a local solution holding unit 32.

The evaluation processing unit 31 receives the data D1_L_min transmitted from the first determination processing unit 12 and the data D2_L_min transmitted from the second determination processing unit 23. The evaluation processing unit 31 performs evaluation processing using the data D1_L_min and the data D2_L_min (described in detail later), and transmits data including the result of the processing (data on the local solution(s)) to the local solution holding unit 32 as data D31. Also, the evaluation processing unit 31 reads out data (data for local solution) that has been stored in the local solution holding unit 32, and performs evaluation processing using the read-out data, the data D1_L_min, and the data D2_L_min to obtain optimal solution data (described in detail later). The evaluation processing unit 31 then transmits data including the obtained optimal solution data as data D_best_sol.

### 1.2: Operation of Data Processing Apparatus

The operation of the data processing apparatus 100 configured as above will be described below.

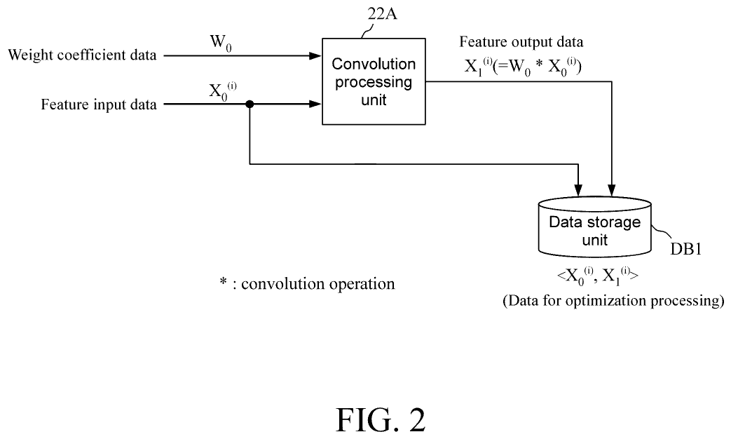

FIG. 2 is a diagram for explaining data for optimization processing in the data processing apparatus 100.

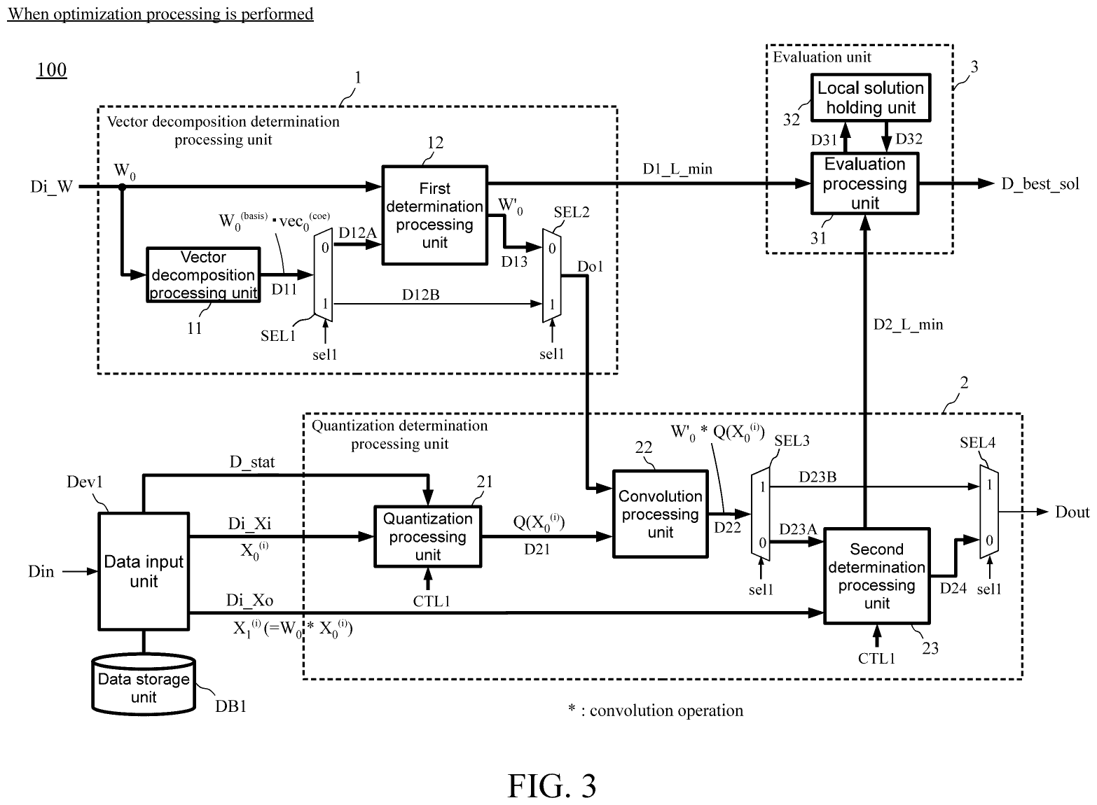

FIG. 3 is a schematic configuration diagram of the data processing apparatus 100 and is a diagram for explaining an operation when optimization processing is performed.

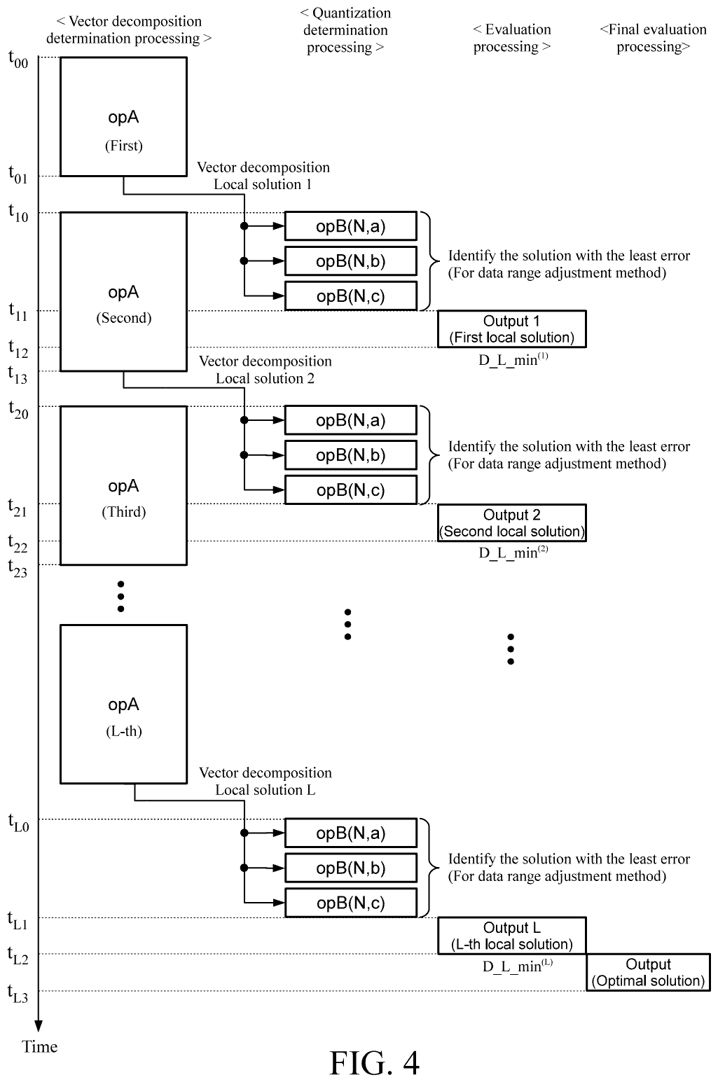

FIG. 4 is a sequence diagram of optimization processing (timing chart) performed in the data processing apparatus 100.

First it is assumed that feature output data obtained by performing convolution processing on weight coefficient data and feature input data have been stored in the data storage unit DB1. In other words, as shown in FIG. 2, weight coefficient data W₀ and feature input data X₀⁽ⁱ⁾ are inputted into a convolution processing unit 22A that performs the same quantization processing as the convolution processing unit 22 of the quantization determination processing unit 2 of the data processing apparatus 100; quantization processing is performed; and then the resultant data (feature output data (data corresponding to feature map(s) outputted from the convolutional layer(s))) X₁⁽ⁱ⁾ (=W₀*X₀⁽ⁱ⁾, “*” represents an operator for performing quantization processing) of the quantization processing with the weight coefficient W₀ and the feature input data X₀⁽ⁱ⁾ (data corresponding to feature map(s) inputted into convolutional layer(s)) is stored in the data storage unit DB1. Multiple pieces of resultant data (feature output data) of convolution processing by performing the above processing repeatedly are obtained (e.g., the certain number of pieces of resultant data (feature output data) X₁⁽¹⁾ to X₁^{(N)} (N is a natural number) of convolution processing by performing the above processing on feature input data X₀⁽¹⁾ to X₀^{(N)}), and then the obtained multiple pieces of resultant data of convolution processing (feature output data) are stored in the data storage unit DB1.

This allows for preparing data for optimization processing that is subjected to convolution processing.

In an example, a case will now be described in which the data processing apparatus 100 performs optimization processing using data for optimization processing (data sets <X₀⁽ⁱ⁾, X₁⁽ⁱ⁾> (i is a natural number satisfying 1≤i≤N) stored in the data storage unit DB1) that has been obtained by the above processing. In addition, data processing (prediction processing) performed in the data processing apparatus 100 after the optimization processing will be described. For convenience of description, description will be made in the following assuming that the weight coefficient data W₀, the feature input data X₀⁽ⁱ⁾, and the feature output data X₁⁽ⁱ⁾ are n×1 matrixes (vertical vector). Note that the weight coefficient data (weight filter (kernel)), the feature input data (feature map (input into the convolutional layer(s)), and the feature output data (feature map (output from the convolutional layer(s)) may be nixmi matrixes (n₁, m₁ are natural numbers); in this case, the weight coefficient data W₀, the feature input data X₀⁽ⁱ⁾, and the feature output data X₁⁽ⁱ⁾ may be data (data in which the elements of an nixmi matrix are arranged inn columns) obtained by converting the above data (n₁×m₁ matrix) to an n×1 matrix (vertical vector), in which n satisfies n=n₁×m₁.

### 1.2.1: Optimization Processing

First, optimization processing performed in the data processing apparatus 100 will be described.

### First Vector Decomposition Determination Processing (Time t₀₀ to t₀₁)

The vector decomposition processing unit 11 of the vector decomposition determination processing unit 1 receives the data Di_W including the weight coefficient matrix W₀ (n×1 matrix), and performs vector decomposition processing on the data Di_W. Specifically, the vector decomposition processing unit 11 performs processing for obtaining a basis matrix W₀^{(basis)} and a real number coefficient vector vec₀^{(coe)}, which satisfy the following.
Norm(W₀−W₀^{(basis)}·vec₀^{(coe)})<ε
W₀: weight coefficient matrix W₀ (n×1 matrix)
W₀^{(basis)}: basis matrix (a matrix whose elements are basis data (n×k matrix))
Vec₀^{(coe)}: real number coefficient vector (a vector whose elements are real numbers (k×1 matrix))
Norm( ): a function that takes a norm
ε: allowable error

When the basis data is assumed to be {−1, 1}, for example, the basis matrix W₀^{(basis)} is W₀^{(basis)}∈{−1, 1}^{n×k}. Note that the basis (basis data) may be a set whose elements are arbitrary numbers, and furthermore the number of elements included in the set may be any numbers.

First, the vector decomposition processing unit 11 performs processing corresponding to the following formula to obtain a local solution Mₒₚₜ of a basis matrix M and a local solution cₒₚₜ of a real number coefficient vector c.

$${M}_{opt} , {c}_{opt} = {argmin}_{M , c} {‖ w - M c ‖}_{2}^{2} \qquad Formula 1$$

w: weight coefficient matrix (n×1 matrix) (w=W₀)
M: basis matrix (n×k matrix)
c: real number coefficient vector (k×1 matrix)
the vector decomposition processing unit 11 then sets as follows:

W₀^{(basis)}=Mₒₚₜ

vec₀^{(coe)}=cₒₚₜ

The vector decomposition processing unit 11 transmits data including the resultant data (W₀^{(basis)}·vec₀^{(coe)}) obtained by the above-described vector decomposition processing to the first selector SEL1 as data D11. In accordance with the selection signal sel1, the first selector SEL1 transmits the data D11 transmitted from the vector decomposition processing unit 11 to the first determination processing unit 12 as data D12A. When optimization processing is performed, the signal value of the selection signal sel1 (a signal value to select the terminal 0) is assumed to be set to “0” by the control signal.

Note that data obtained by performing the processing according to the above Formula 1 may not always be the optimal solution, but may be a local solution. This is because the processing according to the above Formula 1 is performed, for example, as follows.

(1) The real number coefficient vector c is initialized by random numbers, and the basis matrix M is randomly initialized by the basis values (e.g., when a set of basis values is {−1, 1}, the basis matrix M is initialized by setting each element of the basis matrix to a value that has been randomly selected from {−1, 1}).
(2) The basis matrix M is fixed, and then the real number coefficient vector c is calculated using the method of least squares (when M is a regular matrix, the real number coefficient vector c is calculated by the formula c=(M^{T}·M)⁻¹·(M^{T}·w) or is obtained by using the method of gradient descent).
(3) The real number coefficient vector c is fixed, and then processing corresponding to the following formula (e.g., processing for obtaining a minimum value of Norm(w—M·c) by full-searching possible matrixes for M) is performed.

$${M}^{′} = {argmin}_{M} {‖ w - M c ‖}_{2}^{2} \qquad Formula 2$$

(4) The above processing (1) to (3) is repeatedly performed until Norm(w−M·c)<ε is satisfied (converged).

The vector decomposition processing unit 11 transmits the data D11 including the resultant data (W₀^{(basis)}·vec₀^{(coe)}) obtained by the above vector decomposition processing (obtained when the processing has been converged) to the first selector SEL1; the first selector SEL1 transmits the data D11 to the first determination processing unit 12 as data D12A.

The first determination processing unit 12 receives the data Di_W including the weight coefficient matrix W₀ and the data D12A (the resultant data W₀^{(basis)}·vec₀^{(coe)})) of the vector decomposition processing) transmitted from the first selector SEL1. The first determination processing unit 12 performs first determination processing using the data Di_W and the data D12A. Specifically, the first determination processing unit 12 obtains a norm of the difference between the resultant data (W₀^{(basis)}·vec₀^{(coe)}) of the vector decomposition processing obtained by the vector decomposition processing unit 11 and the weight coefficient matrix W₀, and then transmits data including the obtained the norm of the difference and data including the resultant data (W₀^{(basis)}·vec₀^{(coe)}) of the vector decomposition processing to the evaluation unit 3 as data D1_L_min.

Also, the first determination processing unit 12 transmits data including the resultant data (W₀^{(basis)}·vec₀^{(coe)}) (this is referred as data W₀′) (data including W₀^{(basis)} and vec₀^{(coe)} in a distinguishable state) of the vector decomposition processing to the second selector SEL2 as data D13. In accordance with the selection signal sel1 (the selection signal sel1 whose signal value indicates to select the terminal 0), the second selector SEL2 transmits the data D13 to the convolution processing unit 22 of the quantization determination processing unit 2 as data Do1.

Note that the above-described processing (first vector decomposition determination processing) is processing indicated by opA from time t₀₀ to t₀₁ in FIG. 4.

### First Quantization Determination Processing (Time t₁₀ to t₁₁)

The data input unit Dev1 reads out N pieces of feature input data X₀⁽¹⁾ to X₀^{(N)} stored in the data storage unit DB1, and performs statistical processing on the data. Specifically, the data input unit Dev1 performs processing according to the following (a) to (c) to obtain statistical data on the N pieces of feature input data X₀⁽¹⁾ to X₀^{(N)}.

(a) The maximum and minimum values of the element values of N pieces of feature input data X₀⁽¹⁾ to X₀^{(N)} are obtained.
(b) An average value and a standard deviation of the element values of N pieces of feature input data X₀⁽¹⁾ to X₀^{(N)} are obtained (calculated).
(c) Data specifying an interquartile range of the element values of N pieces of feature input data X₀⁽¹⁾ to X₀^{(N)} is obtained (e.g., the values of all elements of the N feature input data X₀⁽¹⁾ to X₀^{(N)} are sorted in ascending order and then the value Q1 (first quartile) at the 25% position from the beginning and the value Q3 (third quartile) at the 75% position from the beginning in the data after sorting in ascending order are obtained).

The input data unit Dev1 transmits data including the statistical data obtained by the above processing to the quantization processing unit 21 as data D_stat.

Also, the data input unit Dev1 reads out feature input data X₀⁽ⁱ⁾ and feature output data X₁⁽ⁱ⁾, which are data for i=1, from the data storage unit DB1, (1) transmits data including the read-out feature input data X₀⁽ⁱ⁾ for i=1 to the quantization processing unit 21 as data Di_Xi, and (2) transmits data including the read-out feature output data X₁⁽ⁱ⁾ for i=1 to the second determination processing unit 23 as data Di_Xo.

The quantization processing unit 21 of the quantization determination processing unit 2 receives the data Di_Xi and D_stat transmitted from the data input unit Dev1. In this embodiment, it is assumed that the data D_stat includes the maximum value, the minimum value, the average value, the standard deviation, the first quartile Q1, and the third quartile Q3 of data values of the feature input data (values of the individual elements of the N pieces of feature input data X₀⁽¹⁾ to X₀^{(N)}).

The quantization processing unit 21 also receives the control signal CTL1 that is transmitted from the control unit controlling each functional unit of the data processing apparatus 100 and that indicates a method for providing data range adjustment processing. In this embodiment, it is assumed that the data range adjustment processing is one of the following (a) to (c), and the method to be selected is instructed by the control signal CTL1.

### (a) Data Range Adjustment Method by Normalization Using Maximum and Minimum Values

Assuming that the data values of the feature input data (values of the individual elements of the N pieces of feature input data X₀⁽¹⁾ to X₀^{(N)}) are x, the maximum value of the values x is xₘₐₓ, the minimum value of the values x is xₘᵢₙ, and values after data range adjustment are x′, the quantization processing unit 21 performs processing according to the following formula to obtain the values x′ after data range adjustment.

x′=(x−xₘᵢₙ)/(xₘₐₓ−xₘᵢₙ)

This regulates the values x′ after data range adjustment to a range of [0, 1].

### (b) Data Range Adjustment Method by Standardization

Assuming that the average value of the data values of the feature input data (values of the individual elements of the N pieces of feature input data X₀⁽¹⁾ to X₀^{(N)}) is the standard deviation thereof is σ, and values after data range adjustment are x′, the quantization processing unit 21 performs processing according to the following formula to obtain the values x′ after data range adjustment.

x′=(x−μ)/σ

This causes the average of the values x′ after data range adjustment to be “0”, and causes the standard deviation to be “1”.

### (c) Data Range Adjustment Method Based on an Interquartile Range

Assuming that the first quartile of the data values of the feature input data (values of the individual elements of the N pieces of feature input data X₀⁽¹⁾ to X₀^{(N)}) is Q1, the third quartile thereof is Q3, and values after data range adjustment are x′, the quantization processing unit 21 performs processing according to the following formula to obtain the values x′ after data range adjustment.

xₜₘₚ=limit(x, xᵤₚₚₑᵣ, x_{btm})

xᵤₚₚₑᵣ=Q3+(Q3−Q1)×1.5

x_{btm}=Q1−(Q3−Q1)×1.5

x′=(xₜₘₚ−x_{btm})/(xᵤₚₚₑᵣ−x_{btm})

limit(x, xᵤₚₚₑᵣ, x_{btm}): a function that performs limit processing using the upper limit value xᵤₚₚₑᵣ and the lower limit value x_{btm} (a function that (1) when x>xᵤₚₚₑᵣ is satisfied, outputs xᵤₚₚₑᵣ, (2) when x<x_{btm} is satisfied, outputs x_{btm}, and (3) when x_{btm}≤x≤xᵤₚₚₑᵣ is satisfied, outputs x).

This regulates the values x′ after data range adjustment to a range of [0, 1].

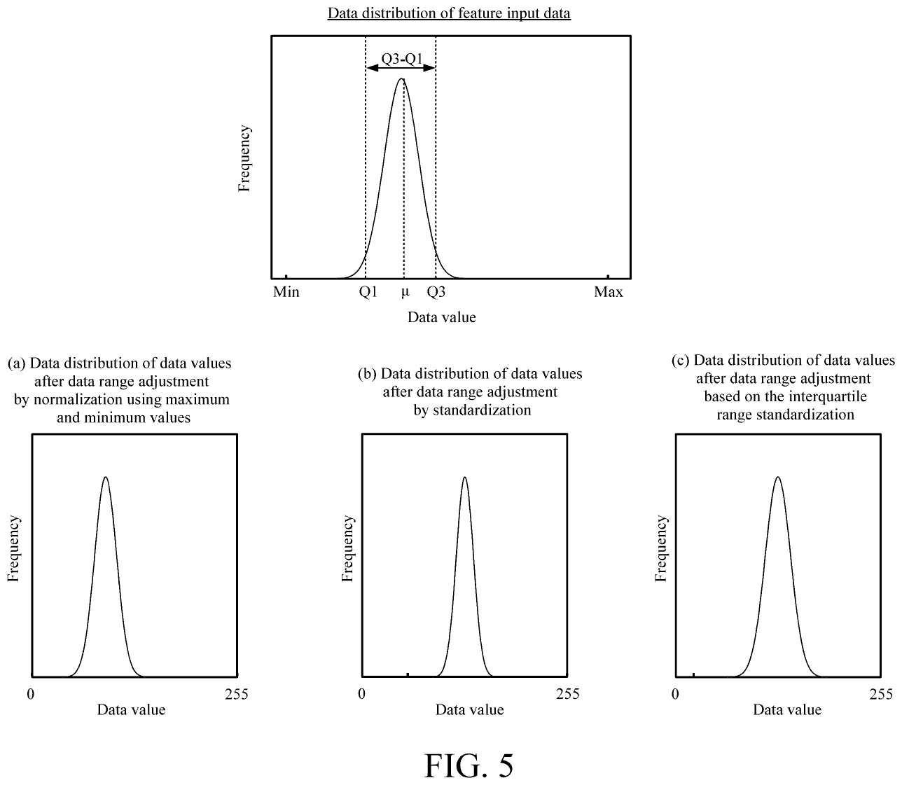

FIG. 5 is a diagram for explaining data range adjustment processing. The upper portion of FIG. 5 is a diagram indicating an example of data distribution of data values x (values of the individual elements of the N pieces of feature input data X₀⁽¹⁾ to X₀^{(N)}) of feature input data

The lower left portion of FIG. 5 is a diagram indicating data distribution of data values after (a) data range adjustment by normalization using maximum and minimum values.

The lower middle portion of FIG. 5 is a diagram indicating data distribution of data values after (b) data range adjustment by standardization.

The lower right portion of FIG. 5 is a diagram indicating data distribution of data values after (c) data range adjustment based on the interquartile range standardization.

Note that, in the lower portion of FIG. 5, data values after data range adjustment are adjusted (adjusted with a certain gain and/or an offset) so that the data values after data range adjustment are 8-bit values (values in a range from 0 to 255).

The control unit sets the signal value of the control signal CTL1 to a signal value indicating (a) the data range adjustment method by normalization using maximum and minimum values, and then transmits it to the quantization processing unit 21 and the second determination processing unit 23.

In accordance with the control signal CTL1, the quantization processing unit 21 obtains the values x′ after data range adjustment by (a) the data range adjustment method by normalization using maximum and minimum values. This processing is performed on the values of the individual elements of the feature input data X₀⁽ⁱ⁾; the quantization processing is performed on the values after data adjustment. Data obtained by the above processing is referred to as data Q(X₀⁽ⁱ⁾).

The quantization processing unit 21 then transmits data including the data Q(X₀⁽ⁱ⁾) obtained by the above processing to the convolution processing unit 22 as data D21.

The convolution processing unit 22 receives the data Do1 transmitted from the vector decomposition determination processing unit 1 and the data D21 transmitted from the quantization processing unit 21. The convolution processing unit 22 performs convolution processing (processing corresponding to W₀′*Q(X₀⁽ⁱ⁾)) on the data Do1(W₀′) and the data D21(Q(X₀⁽ⁱ⁾)), and then transmits data after convolution processing to the third selector SEL3 as data D22. In accordance with the selection signal sel1 from the control unit, the third selector SEL3 selects the terminal “0” to transmit the inputted data D22 to the second determination processing unit 23 as data D23A.

The second determination processing unit 23 receives the data Di_Xo including the feature output data X₁⁽ⁱ⁾, the data D23A (data W₀′*Q(X₀⁽ⁱ⁾) after data range adjustment processing by normalization using maximum and minimum values and quantization processing) transmitted from the third selector SEL3, and the control signal CTL1 transmitted from the control unit (not shown). The second determination processing unit 23 performs second determination processing using the data Di_Xo (feature output data X₁⁽ⁱ⁾) and the data D23A (the data W₀′*Q(X₀⁽ⁱ⁾) after data range adjustment processing by normalization using maximum and minimum values and quantization processing). Specifically, the second determination processing unit 23 obtains the difference (e.g., a norm of the difference) between the feature output data X₁⁽ⁱ⁾ and the data W₀′*Q(X₀⁽ⁱ⁾) after data range adjustment processing by normalization using maximum and minimum values and quantization processing. This difference data is referred to as diff⁽ⁱ⁾(a).

For i=1 to i=N, the above-described processing ((1) data read-out processing by the data input unit Dev1, (2) data range adjustment processing and quantization processing in the quantization processing unit 21, (3) convolution processing by the convolution processing unit 22, and (4) second determination processing by the second determination processing unit 23) is performed (performed with the data X₀⁽ⁱ⁾ and X₁⁽ⁱ⁾).

The second determination processing unit 23 then obtains data Ave_diff(N, a), which is data of the average value of difference data diff⁽ⁱ⁾(a) (1≤i≤N) that has been obtained using each of the N pieces of data (data X₀⁽ⁱ⁾, X₁⁽ⁱ⁾ (individual data from i=1 to i=N)). In other words, the second determination processing unit 23 performs processing according to the following formula to obtain difference average data Ave_diff(N, a).

$$Ave\_diff ( N , a ) = \frac{1}{N} {\sum }_{i = 1}^{N} {diff}^{( i )} ( a ) \qquad Formula 3$$

This processing corresponds to processing opB(N, a) in the sequence diagram of FIG. 4.

The second determination processing unit 23 then transmits data including the difference average data Ave_diff(N, a) obtained in the processing opB(N, a) and the data specifying the data range adjustment processing used when the data has been obtained (data indicating that it is (a) the data range adjustment method by normalization using maximum and minimum values) to evaluation unit 3 as data D2_L_min.

Furthermore, the data input unit Dev1 and the quantization determination processing unit 2 perform the same processing as the above processing (the processing opB(N, a)) by setting the data range adjustment processing in the quantization processing unit 21 to (b) the data range adjustment processing by standardization or (c) the data range adjustment processing based on an interquartile range. Note that the selection for the data range adjustment processing is performed in accordance with the control signal CTL1 from the control unit. It is assumed that processing in which the data range adjustment processing in the quantization processing unit 21 is set to (b) the data range adjustment processing by standardization and then difference average data Ave_diff(N, b) (an average value of N pieces of data diff⁽ⁱ⁾(b) (1≤i≤N)) is obtained is referred to as processing opB(N, b). It is assumed that processing in which the data range adjustment processing in the quantization processing unit 21 is set to (c) the data range adjustment processing based on an interquartile range and then difference average data Ave_diff(N, c) (an average value of N pieces of data diff⁽ⁱ⁾(c) (1≤i≤N)) is obtained is referred to as processing opB(N, c).

After performing the processing opB(N, b), the second determination processing unit 23 transmits data including the difference average data Ave_diff(N, b) obtained by the processing opB(N, b) and the data specifying the data range adjustment processing when the data has been obtained (data indicating that it is (b) the data range adjustment method by standardization) to the evaluation unit 3 as data D2_L_min.

After performing the processing opB(N, c), the second determination processing unit 23 transmits data including the difference average data Ave_diff(N, c) obtained by the processing opB(N, c) and the data specifying the data range adjustment processing when the data has been obtained (data indicating that it is (c) the data range adjustment method based on an interquartile range) to the evaluation unit 3 as data D2_L_min.

### First Evaluation Processing (Time t₁₁ to t₁₂)

The evaluation processing unit 31 of the evaluation unit 3 performs evaluation processing using the data D1_L_min inputted from the first determination processing unit 12 and the data D2_L_min inputted from the second determination processing unit 23.

Specifically, the evaluation processing unit 31 performs processing as follows.

(1) The evaluation processing unit 31 obtains the basis matrix W₀^{(basis)} and the real number coefficient vector vec₀^{(coe)}, which are resultant data of the vector decomposition processing, from the data D1_L_min.
(2a) The evaluation processing unit 31 obtains the difference average data Ave_diff(N, a) obtained by the processing opB(N, a) and data specifying the data range adjustment processing used when the data has been obtained (data indicating that it is (a) the data range adjustment method by normalization using maximum and minimum values) from the data D2_L_min outputted after the processing opB(N, a).
(2b) The evaluation processing unit 31 obtains the difference average data Ave_diff(N, b) obtained by the processing opB(N, b) and data specifying the data range adjustment processing used when the data has been obtained (data indicating that it is (b) the data range adjustment method by standardization) from the data D2_L_min outputted after the processing opB(N, b).
(2c) The evaluation processing unit 31 obtains the difference average data Ave_diff(N, c) obtained by the processing opB(N, c) and data specifying the data range adjustment processing used when the data has been obtained (data indicating that it is (c) the data range adjustment method based on an interquartile range) from the data D2_L_min outputted after the processing opB(N, c).

The evaluation processing unit 31 then performs processing according to the following formula to obtain the minimum value minAve.

minAve=min(Ave_diff(N,a), Ave_diff(N,b), Ave_diff(N,c))
min( ): a function to obtain a minimum value of elements.

The evaluation processing unit 31 sets data including (1) the basis matrix W₀^{(basis)} (this data is referred to as W₀^{(basis)(1)}) that is resultant data of vector decomposition processing obtained from the data D1_L_min and the real number coefficient vector vec₀^{(coe)} (this data is referred to as vec₀^{(coe)(1)}), (2) the minimum value min Ave obtained by the above processing (this data is referred to as minAve⁽¹⁾), and (3) data specifying data range adjustment processing that takes the minimum value of the difference average data (this data is referred to as D_{mthd}⁽¹⁾) to first local solution data D_L_min(1)={W₀^{(basis)(1)}, vec₀^{(coe)(1)}, minAve⁽¹⁾, D_{mthd}⁽¹⁾}. Also, the evaluation processing unit 31 transmits the first local solution data D_L_min(1) to the local solution holding unit 32 as data D31, and the local solution holding unit 32 stores the data.

### Second Vector Decomposition Determination Processing (Time t₁₀ to t₁₃)

During a period from time t₁₀ to time t₁₃, the data processing apparatus 100 performs second vector decomposition determination processing. Note that the second vector decomposition processing is performed in parallel with the first quantization determination processing as shown in FIG. 4. This can speed up the processing. In other words, performing the vector decomposition processing in parallel with the quantization determination processing allows for improving the speed of the processing (the entire processing) performed in the data processing apparatus 100.

In the second vector decomposition determination processing, the vector decomposition processing unit 11 of decomposition determination processing unit 1 performs vector decomposition processing with an initial value different from the initial value that has been set in the first vector decomposition determination processing. In other words, data obtained by performing processing according to Formula 1 may be a local solution instead of an optimal solution depending on what values the initial values of the real number coefficient vector c and/or the initial values of the basis matrix M are set to in the vector decomposition processing performed in the vector decomposition processing unit 11.

Thus, the vector decomposition processing unit 11 performs the processing with the initial values that are to be changed (e.g., the initial values are to be changed by using random numbers) every time it performs the processing (vector decomposition processing) according to Formula 1. For other processing, the second vector decomposition determination processing is the same as the first vector decomposition determination processing.

In the second vector decomposition determination processing, the same processing as the first vector decomposition determination processing is performed. Note that the basis matrix W₀^{(basis)} of the resultant data of the vector decomposition processing included in the data D1_L_min transmitted from the first determination processing unit 12 to the evaluation processing unit 31 is referred to as W₀^{(basis)(2)}, and the real number coefficient vector vec₀^{(coe)} is referred to as vec₀^{(coe)(2)}.

### Second Quantization Determination Processing (Time t₂₀ to t₂₁)

During a period from time t₂₀ to time t₂₁, the data processing apparatus 100 performs second quantization determination processing. In the second quantization determination processing, the same processing as the first quantization determination processing is performed. Note that in the second quantization determination processing, data included in the data Di_Xi transmitted from the data input unit Dev1 to the quantization processing unit 21 is X₀⁽ⁱ⁾ (i=2), data transmitted from the data input unit Dev1 to the second determination processing unit 23 is X₁⁽ⁱ⁾ (i=2), the data Do1 inputted from the vector decomposition determination processing unit 1 to the convolution processing unit 22 is data obtained by the second vector decomposition determination processing.

### Second Evaluation Processing (Time t₂₁ to t₂₂)

During a period from time t₂₁ to time t₂₂, the data processing apparatus 100 performs second evaluation processing. In the second evaluation processing, the same processing as the first evaluation processing is performed. Note that in the second evaluation processing, local solution data obtained by the evaluation processing unit 31 is set to the second local solution data D_L_min⁽²⁾={W₀^{(basis)(2)}, vec₀^{(coe)(2)}, minAve⁽²⁾, D_{mthd}⁽²⁾}.

### Third to (L−1)-th Vector Decomposition Determination Processing, Quantization Determination Processing, and Evaluation Processing

In the third to (L−1)-th vector decomposition determination processing, quantization determination processing, and evaluation processing, the data processing apparatus 100 performs the same vector decomposition determination processing, quantization determination processing, and evaluation processing as the second vector decomposition determination processing, the second quantization determination processing, and the second evaluation processing, respectively.

### L-th Vector Decomposition Determination Processing and Quantization Processing

In the L-th vector decomposition determination processing and quantization processing, the data processing apparatus 100 performs the same vector decomposition determination processing and quantization processing as the second vector decomposition determination processing and the second quantization processing, respectively.

### L-th Evaluation Processing

During a period from time t_{L1} to t_{L2}, the data processing apparatus 100 performs L-th evaluation processing. In the L-th evaluation processing, the same processing as the first evaluation processing is performed. Note that in the L-th evaluation processing, the local solution obtained by the evaluation processing unit 31 is assumed to be the L-th local solution data D_L_min^{(L)}={W₀^{(basis)(L)}, vec₀^{(coe)(L)}, minAve^{(L)}, D_{mthd}^{(L)}}.

The evaluation processing unit 31 identifies local solution data with the minimum value of minAve^{(j)} (j is a natural number satisfying 1≤j≤L) among L pieces of local solution data, which are the first local solution data D_L_min⁽¹⁾ to the L-th local solution data D_L_min^{(L)}. Note that the evaluation processing unit 31 reads out the first local solution data D_L_min⁽¹⁾ to the L-th local solution data D_L_min^{(L)} from the local solution holding unit 32.

The evaluation processing unit 31 then obtains the local solution data with minimum value of minAve^{(j)} (when j=j0, the minAve^{(j)} is assumed to take the minimum value) as optimal solution data D_best_sol={W₀^{(basis)(j0)}, vec₀^{(coe)(j0)}, minAve^{(j0)}, D_{mthd}^{J0)}}. Note that the local solution data obtained when j=j0 is satisfied is assumed to be local solution data with the minimum value of minAve^{(j)}.

The evaluation processing unit 31 then transmits the obtained optimal solution D_best_sol (processing during a period from time t_{L2} to time t_{L3}).

As described above, the data processing apparatus 100 determines the optimal solution ({W₀^{(basis)(j0)}, vec₀^{(coe)(j0)}}) of the vector decomposition processing and the optimal method (the method specified by D_{mthd}^{(j0)}) of the data adjustment processing (e.g., data range adjustment processing) before the quantization processing when the convolution processing is to be performed on N pieces of the feature input data X₀⁽ⁱ⁾.

### 1.2.2: Data Processing (Prediction Processing)

Next, data processing (prediction processing) performed in the data processing apparatus 100 will be described.

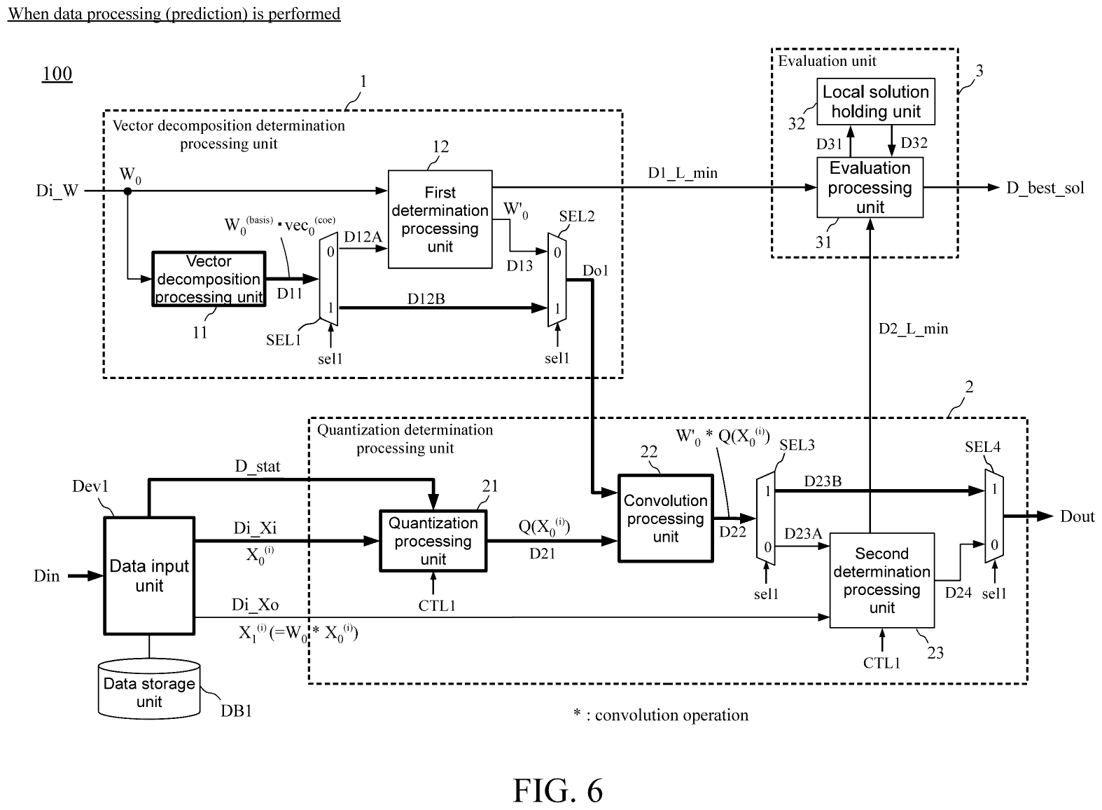

FIG. 6 is a schematic configuration diagram of the data processing apparatus 100 and is a diagram for explaining an operation when data processing (prediction processing) is performed.

The optimal solution ({W₀^{(basis)(j0)}, vec₀^{(coe)(j0)}}) for performing convolution processing and the optimal method of the data adjustment processing before the quantization processing (the method specified by D_{mthd}^{(j0)}), which have been obtained by the above-described optimal processing in the data processing apparatus 100, are set in the vector decomposition processing unit 11 and the quantization processing unit 21. In other words, the convolution processing unit 22 is set so that the basis matrix W₀^{(basis)(j0)} and the real number coefficient vector vec₀^{(coe)(j0)}, which are optimal solutions, are transmitted from the vector decomposition processing unit 11 to the convolution processing unit 22; furthermore, the quantization processing unit 21 is set so that the data adjustment processing is to be performed using the optimal method specified by D_{mthd}^{(j0)}.

Note that the control unit sets the signal value of the selection signal sel1 to “1” when data processing is performed (prediction processing is performed), and transmits the selection signal to the first selector SEL1, the second selector SEL2, the third selector SEL3, and the fourth selector SEL4 for the terminal 1 to be selected.

The data input unit Devl receives input data Din, and transmits the data (or data after performing data adjustment processing on the input data if needed) to the quantization processing unit 21 as data Di_Xi. Note that the data input unit Dev1 receives a certain amount of input data Din, holds it, obtains statistical data, that is, statistical data for the values of elements of the input data Din (the maximum, minimum, average, standard deviation, first quartile, and/or third quartile thereof), and then transmits data including the obtained statistical data to the quantization processing unit 21 as data D_stat.

Using the statistical data D_stat inputted from the data input unit Dev1, the quantization processing unit 21 performs data adjustment processing by the method specified by D_{mthd}^{(j0)}, which is the optimal solution of the data adjustment processing. The quantization processing unit 21 then performs quantization processing on the data after data adjustment, and transmits data after quantization processing to the convolution processing unit 22 as data D21.

Using the basis matrix W₀^{(basis)(j0)} and the real number coefficient vector vec₀^{(coe)(j0)} that are optimal solutions and are transmitted from the vector decomposition processing unit 11, the convolution processing unit 22 performs convolution processing on the data D21 transmitted from the quantization processing unit 21, and then transmits data after convolution processing to the third selector SEL3 as data D22. The third selector SEL3 transmits the data D22 to the fourth selector SEL4 as data D23B; the fourth selector SEL4 transmits the data D23B (=D22) as data Dout.

This allows the data processing apparatus 100 to perform data processing (prediction processing). Note that the data processing (prediction processing) in the data processing apparatus 100, for example, corresponds to processing performed by portion(s) that is(are) to perform convolution processing in convolutional layer(s) of a neural network model. Thus, the portion(s) that is(are) to perform convolution processing in convolutional layer(s) of the neural network model may be provided (implemented) by a functional unit that provides the same function as the function provided by the data processing apparatus 100 as describe above (a functional unit in which the optimal solutions of the basis matrix of vector decomposition, the real number coefficient vector, and the data adjustment processing for quantization processing obtained by the optimization processing have been set).

### Summary of the Embodiment

As described above, the data processing apparatus 100 obtains a plurality of local solutions (L local solutions) in the vector decomposition processing, selects a plurality of data adjustment processes performed before the quantization processing for each of the obtained local solutions of the vector decomposition processing, obtains the accuracy of the convolution processing (error between the obtained data and the supervised data X₁⁽ⁱ⁾=W₀*X₀⁽ⁱ⁾), and then determines a local solution of the vector decomposition processing with highest accuracy and the data adjustment processing, with highest accuracy, performed before the quantization. The data processing apparatus 100 performs the data processing (prediction processing) using the local solution of the vector decomposition processing and the data adjustment processing performed before the quantization processing that are determined by the above-described processing (optimization processing); this allows the data processing apparatus 100 to perform data processing along with quantization, convolution processing, or the like with high accuracy using the optimal basis matrix and the optimal real number coefficient vector for feature input data with any data distribution.

In particular, for feature input data with data distribution having outlier(s), when outlier(s) is(are) excluded and then batch normalization processing is performed on feature input data with data distribution having outlier(s) like conventional techniques, the accuracy of the convolution processing may deteriorate (e.g., in a case where the feature input data has sparse data distribution and the outlier(s) has(have) significant meaning, excluding the outlier(s) of the feature input data sometimes deteriorates the accuracy of the convolution processing); in such a case, the data processing apparatus 100 performs optimal data adjustment processing and then performs quantization, thus allowing for performing convolution processing with high accuracy.

Furthermore, when the data processing apparatus 100 is implemented by hardware, the circuit to be added can be a relatively small-scale circuit using a general-purpose circuit, so that there is no need to adopt a large-scale circuit configuration. As a result, the data processing apparatus 100 that performs processing with high accuracy is provided by using hardware (the hardware may include a portion that performs software processing) while reducing circuit scale and cost.

### Other Embodiments

In the above description, a case where the vector decomposition processing is performed L times in the data processing apparatus 100, but the present invention should not be limited to this. For example, the data processing apparatus 100 obtains a norm (e.g., matrix norm, Frobenius norm, or the like) (or sum of squared error or cross-entropy error) of the difference between the weight coefficient matrix W₀ and the product W₀^{(basis)}·vec₀^{(coe)} of the local solution basis matrix W₀^{(basis)} and the local solution real number coefficient vector vec₀^{(coe)} that have been obtained by the L′-th vector decomposition processing, L′ being a natural number satisfying L′<L; and when the obtained norm is less than a predetermined threshold, the data processing apparatus 100 may not perform the subsequent vector decomposition processing after the L′-th vector decomposition processing (may interrupt the subsequent vector decomposition processing after the L′-th vector decomposition processing). In that case, the evaluation unit 3 of the data processing apparatus 100 may obtain the optimal solution data using data that has been obtained up to the L′-th vector decomposition processing. Performing as described above allows for interrupting the subsequent processing (preventing subsequent processing from performing) when highly accurate data (data with minimal error) has been obtained by the vector decomposition processing, thus speeding up the processing.

In the above description, a case where the number of pieces of data transmitted from the data input unit Dev1 to the quantization determination processing unit 2 in the data processing apparatus 100 when the optimization processing is performed is N has been described. The number N of pieces of data may be set to a number corresponding to the number of training data (e.g., the number corresponding to one batch (one epoch) (the total number of training data)) used in training processing in a neural network model with convolutional layer(s) having functions of the optimized quantization processing unit 21 and the optimized convolution processing unit 22. Also, the number N of pieces of data may be set to the same number as the number of pieces of data making up one mini-batch used when the above-described neural network model is trained. Also, the number N of pieces of data may be set to other numbers not described above.

In the above embodiment, a quantization step (a quantization width) in the quantization processing has not been described, but the quantization step (the quantization width) may be set to a fixed value or a variable value.

In the above embodiment, for convenience of explanation, the explanation has been made assuming a case where a kernel size (a size of a weight coefficient matrix (a size of a weight coefficient filter)) is identical to a size of a feature map (a size of feature input data (a matrix)), and the number of channels is “1”, but the present invention should not be limited to this.

The kernel size may be smaller than the size of the feature map; in this case, the data input unit Dev1 extracts data included in a certain range (area) of the feature map in accordance with the kernel size, and the data processing apparatus 100 may perform the above-described processing (optimization processing and data processing (prediction processing)) on the data included in the extracted range (area) in the same manner. Also, when a stride and padding (including with or without padding) used in the convolution processing are set to certain values, the data processing apparatus 100 may perform the above-described processing (optimization processing and data processing (prediction processing)), in the same manner, in accordance with the stride and the padding that have been set (taking into account the stride and the padding that have been set).

Also, when the number of channels is set to two or more, the data processing apparatus 100 may perform the above-described processing (optimization processing and data processing (prediction processing)), in the same manner, in accordance with the number of channels that has been set.

In the above embodiment, a case where the method of the data range adjustment processing includes three methods, that is, (a) data range adjustment method by normalization using maximum and minimum values, (b) data range adjustment method by standardization, and (c) data range adjustment method based on an interquartile range has been described, but the present invention should not be limited to this; other data range adjustment processing method(s) may be added to the above methods, or other data range adjustment processing method(s) may be employed instead of the above methods. For example, in addition to the above three methods, data range adjustment processing in which after excluding outlier(s), (a) data range adjustment method by normalization using maximum and minimum values, (b) data range adjustment method by standardization, and/or (c) data range adjustment method based on an interquartile range are performed may be employed.

Each block of the data processing apparatus 100 device described i n the above embodiments may be formed using a single chip with a semic onductor device, such as LSI, or some or all of the blocks of the data pro cessing apparatus 100 may be formed using a single chip. Further, each bl ock (each functional unit) of the data processing apparatus described in the above embodiments may be implemented with a semiconductor device such as a plurality of LSIs.

Note that although the term LSI is used here, it may also be calle d IC, system LSI, super LSI, or ultra LSI depending on the degree of inte gration.

Further, the method of circuit integration should not be limited to LSI, and it may be implemented with a dedicated circuit or a general-purpose processor. A field programmable gate array (FPGA) that can be programmed after the LSI is manufactured, or a reconfigurable processor that can reconfigure connection and setting of circuit cells inside the LSI may be used.

Further, a part or all of the processing of each functional block of each of the above embodiments may be implemented with a program. A part or all of the processing of each functional block of each of the above-described embodiments is then performed by a central processing unit (CPU) in a computer. The programs for these processes may be stored in a storage device, such as a hard disk or a ROM, and may be executed from the ROM or be read into a RAM and then executed.

The processes described in the above embodiments may be implemented by using either hardware or software (including use of an operating system (OS), middleware, or a predetermined library), or may be implemented using both software and hardware.

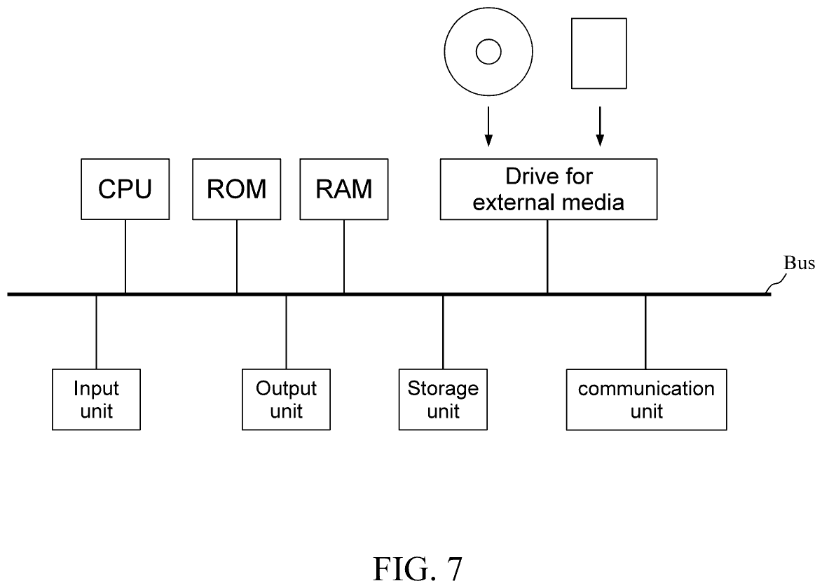

For example, when each functional unit of the above embodiment is achieved by using software, the hardware structure (the hardware structure including CPU(s), GPU(s), ROM, RAM, an input unit, an output unit, or the like, each of which is connected to a bus) shown in FIG. 7 may be employed to achieve the functional units by using software.

When each functional unit of the above embodiment is achieved by using software, the software may be achieved by using a single computer having the hardware configuration shown in FIG. 7, and may be achieved by using distributed processes using a plurality of computers.

The processes described in the above embodiment may not be performed in the order specified in the above embodiment. The order in which the processes are performed may be changed without departing from the scope and the spirit of the invention. Further, in the processing method in the above-described embodiment, some steps may be performed in parallel with other steps without departing from the scope and the spirit of the invention. In addition, in the processing method in the above embodiment, the processing performed in parallel may be performed in series (sequentially).

The present invention may also include a computer program enabling a computer to implement the method described in the above embodiment and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program should not be limited to one recorded on the recording medium, but may be transmitted via an electric communication line, a wireless or wired communication line, a network represented by the Internet, or the like.

The term “unit” may include “circuitry,” which may be partly or entirely implemented by using either hardware or software, or both hardware and software.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

The specific structures described in the above embodiment are mere examples of the present invention, and may be changed and modified variously without departing from the scope and the spirit of the invention.

In addition, in the description in this specification and the description in the scope of claims, “optimization” refers to making the best state, and the parameters for “optimizing” a system (a model) refers to parameters when the value of the objective function for the system is the optimum value. The “optimal value” is the maximum value when the system is in a better state as the value of the objective function for the system increases, whereas it is the minimum value when the system is in a better state as the objective function value for the system decreases. Also, the “optimal value” may be an extremum value. In addition, the “optimal value” may allow a predetermined error (measurement error, quantization error, or the like) and may be a value within a predetermined range (a range for which sufficient convergence for the value can be considered to be achieved).

### Appendixes

Note that the present invention can be achieved as described below.

A first aspect of the present invention provides a data processing apparatus for performing convolution processing on matrix data including a plurality of elements using a weight coefficient matrix, including vector decomposition processing circuitry, quantization processing circuitry, convolution processing circuitry, and evaluation circuitry.

The vector decomposition processing circuitry performs vector decomposition processing of decomposing the weight coefficient matrix into a basis matrix whose elements are basis values and a real number coefficient vector whose elements are real numbers.

The quantization processing circuitry is capable of performing multiple types of data adjustment processing on matrix data, selects one of the multiple types of data adjustment processing, performs the selected data adjustment processing on the matrix data to obtain data after data adjustment processing, and performs quantization processing on the obtained data after data adjustment processing to obtain data after quantization processing.

The convolution processing circuitry performs convolution processing on the data after quantization processing using the basis matrix and the real number coefficient vector that have been obtained in the vector decomposition by the vector decomposition processing circuitry, thereby obtaining data after convolution processing as data after vector decomposition and convolution processing.

The evaluation circuitry obtains an evaluation result based on a correct matrix data, which is data obtained by convolution processing on the matrix data using the weight coefficient matrix, and the data after vector decomposition and convolution processing.

In the data processing apparatus, the quantization processing circuitry selects a plurality of data adjustment processes that are to be performed before quantization processing, convolution processing is performed, and the resultant data of the convolution processing is compared with the correct data, which is data obtained by performing convolution processing using the weight coefficient matrix, thereby allowing for obtaining the accuracy of the convolution processing and allowing for determining the most accurate data adjustment processing that is to be performed before the quantization processing. The data processing apparatus performs, for example, the data processing (prediction processing) using the data adjustment processing performed before the quantization processing that are determined by the above-described processing; this allows the data processing apparatus to perform data processing along with quantization, convolution processing, or the like with high accuracy using the optimal basis matrix and the optimal real number coefficient vector for feature input data with any data distribution, which have been obtained by the vector decomposition processing.

Note that examples of “an evaluation result based on a correct matrix data and the data after vector decomposition and convolution processing” include comparison resultant data based on the difference between the two pieces of data, a norm (matrix norm, Frobenius norm, or the like) of the matrix (a matrix in which each element is a difference between the corresponding elements of the two pieces of data) obtained by the difference between the two pieces of data, data related to the norm, a sum of squared error, and a cross-entropy error.

A second aspect of the present invention provides the data processing apparatus of the first aspect of the present invention in which the vector decomposition processing circuitry initializes the basis matrix using first random numbers and initializes the real number coefficient vector using second random numbers, repeatedly updates the basis matrix and/or the real number coefficient vector so that a matrix obtained by a product of the initialized basis matrix and the initialized real number coefficient vector becomes closer to the weight coefficient matrix, and obtains the basis matrix and the real number coefficient vector when an error between the obtained matrix and the weight coefficient matrix has been within a certain range of error as a local solution basis matrix and a local solution real number coefficient vector.

The convolution processing circuitry performs the convolution processing using the local solution basis matrix and the local solution real number coefficient vector.

Using the basis matrix and the real number coefficient vector which have been initialized with random numbers, the data processing apparatus performs update processing so that the matrix obtained by a product of the basis matrix and the real number coefficient vector becomes closer to the weight coefficient matrix, thereby allowing for obtaining a local solution basis matrix and a local solution real number coefficient vector. The data processing apparatus performs convolution processing using the local solution basis matrix and the local solution real number coefficient vector.

A third aspect of the present invention provides the data processing apparatus of the first or second aspect of the present invention in which the vector decomposition processing circuitry obtains L local solution basis matrixes and L local solution real number coefficient vectors by changing initial settings, L being a natural number equal to or greater than two.

The quantization processing circuitry is capable of performing M types of the data adjustment processing, M being a natural number equal to or greater than two, and performs the M types of the data adjustment processing to obtain M pieces of data after quantization processing. The convolution processing circuitry performs convolution processing on the M pieces data after quantization processing obtained by the quantization processing circuitry using each set of the L local solution basis matrixes and the L local solution real number coefficient vectors.

The evaluation circuitry obtains, as the evaluation result, comparison result (e.g., data of difference, a norm of the difference, a sum of squared error or a cross-entropy error) between the correct matrix data and each data obtained by performing convolution processing on the M pieces of data after quantization processing using each set of the L local solution basis matrixes and the L local solution real number coefficient vectors, determines a combination of the local solution basis matrix and the local solution real number coefficient vector and the type of the data adjustment processing when the comparison result is optimal (when the difference (or the error) is the least or the norm of the difference is the least), and obtains data of the determined combination as optimal solution data of vector decomposition processing and data adjustment processing.

The data processing apparatus obtains a plurality of local solutions (L local solutions) in the vector decomposition processing, selects a plurality of data adjustment processes performed before the quantization processing for each of the obtained local solutions of the vector decomposition processing, obtains the accuracy of the convolution processing, and then determines a local solution of the vector decomposition processing with highest accuracy and the data adjustment processing, with highest accuracy, performed before the quantization. The data processing apparatus performs the data processing (prediction processing) using the local solution of the vector decomposition processing and the data adjustment processing performed before the quantization processing that are determined by the above-described processing (optimization processing); this allows the data processing apparatus to perform data processing along with quantization, convolution processing, or the like with high accuracy using the optimal basis matrix and the optimal real number coefficient vector for feature input data with any data distribution.

A fourth aspect of the present invention provides the data processing apparatus of one of the first to the third aspects of the present invention in which the multiple types of data adjustment processing includes one of:

(1) processing that performs normalization on input data using a maximum value and a minimum value for data distribution of values of elements of matrix data to obtain an output value,
(2) processing that performs standardization on input data using an average value and a standard deviation for data distribution of values of elements of matrix data to obtain an output value, and
(3) processing that performs data range adjustment processing on input data based on a first quartile and a third quartile for data distribution of values of elements of matrix data to obtain an output value.

This allows the quantization processing circuitry in the data processing apparatus to perform data adjustment processing and quantization processing using at least one of the data adjustment processes of (1) to (3) above.

A fifth aspect of the present invention provides the data processing apparatus of the third or the fourth aspect of the present invention in which the vector decomposition processing sequentially obtains L local solution basis matrixes and L local solution real number coefficient vectors by changing initial settings, L being a natural number equal to or greater than two, obtains a norm of a difference between the weight coefficient matrix and a product of a local solution basis matrix and a local solution real number coefficient vector that have been obtained by the L′-th vector decomposition processing, L′ being a natural number satisfying L′<L, and does not perform the subsequent vector decomposition processing after the L′-th vector decomposition processing when the obtained norm is less than a predetermined threshold.

When the vector decomposition processing circuitry does not perform the subsequent vector decomposition processing after the L′-th vector decomposition processing, the evaluation circuitry obtains, as the evaluation result, a comparison result of the correct matrix data and each of data obtained by performing convolution processing on the M pieces of data after quantization using each set of the L′ local solution basis matrixes and the L′ local solution real number coefficient vectors, which have been obtained up to the L′-th vector decomposition processing, determines a combination of the local solution basis matrix and the local solution real number coefficient vector and the type of the data adjustment processing when the comparison result is optimal, and obtains data of the determined combination as optimal solution data of vector decomposition processing and data adjustment processing.

Thus, the data processing apparatus interrupts the subsequent processing (prevents subsequent processing from performing) when highly accurate data (data with minimal error) has been obtained in the middle of the vector decomposition processing, which is performed sequentially, thereby speeding up the processing.

A sixth aspect of the present invention provides the data processing apparatus of one of the third to the fifth aspects of the present invention in which assuming that when each of the M types of the data adjustment processing is performed on N pieces of data as input data, N being a natural number, i-th input data in performing j-th data adjustment processing of the M types of the data adjustment processing is X₀⁽ⁱ⁾(j) and correct data is X₁⁽ⁱ⁾, j being an natural number satisfying 1≤j≤M, i being an natural number satisfying 1≤i≤N, and q-th data that is obtained by multiplying one of the L local solution basis matrixes with its corresponding one of the L local solution real number coefficient vectors is W₀′(q), q being a natural number satisfying 1≤q≤L, the evaluation circuitry performs processing according to the following formula to determine jₒₚₜ and qₒₚₜ, and then obtains data of a combination of the qₒₚₜ-th local solution basis matrix and the qₒₚₜ-th local solution real number coefficient vector and the jₒₚₜ-th data adjustment processing as optimal solution data of vector decomposition processing and data adjustment processing.

$${j}_{opt} , {q}_{opt} = {argmin}_{j , q} Ave\_diff ( N , j , q ) \qquad Formula 4$$

$$Ave\_diff ( N , j , q ) = \frac{1}{N} {\sum }_{i = 1}^{N} ‖ {X}_{1}^{( i )} - {W}_{0}^{′} ( q ) * Q ( {X}_{0}^{( i )} ( j ) ) ‖$$

$$1 \leq j \leq M , 1 \leq q \leq L$$

This allows the data processing apparatus to obtain optimal solutions for the vector decomposition processing and the data adjustment processing based on average difference data obtained by performing each of the M types data adjustment processes with N pieces of data set as input data (N is a natural number).

A seventh aspect of the present invention provides a convolution processing apparatus including quantization processing circuitry and convolution processing circuitry.

After performing data adjustment processing determined by the optimal solution data obtained by the data processing apparatus according to one of the third to the sixth aspects of the present invention on matrix data including a plurality of elements, the quantization processing circuitry performs quantization processing to obtain data after quantization processing.

The convolution processing circuitry performs convolution processing on the data after quantization processing obtained by the quantization processing circuitry using the local solution basis matrix and the local solution real number coefficient vector that are determined by the optimal solution data.

This achieves the convolution processing apparatus that performs convolution processing using the data adjustment processing determined by the optimal solution data obtained by the data processing apparatus according to one of the third to the sixth aspects of the present invention and further using the local solution basis matrix and the local solution real number coefficient vector determined by the optimal solution data.

An eighth aspect of the present invention provides a data processing method for performing convolution processing on matrix data including a plurality of elements using a weight coefficient matrix, including a vector decomposition processing step, a quantization processing step, a convolution processing step, and an evaluation step.

The vector decomposition processing step performs vector decomposition processing of decomposing the weight coefficient matrix into a basis matrix whose elements are basis values and a real number coefficient vector whose elements are real numbers.

The quantization processing step is capable of performing multiple types of data adjustment processing, selects one of the multiple types of data adjustment processing, performs the selected data adjustment processing on the matrix data to obtain data after data adjustment processing, and performs quantization processing on the obtained data after data adjustment processing to obtain data after quantization processing.

The convolution processing step performs convolution processing on the data after quantization processing using the basis matrix and the real number coefficient vector that have been obtained in the vector decomposition by the vector decomposition processing step, thereby obtaining data after convolution processing as data after vector decomposition and convolution processing.

The evaluation step obtains an evaluation result based on a correct matrix data, which is data obtained by convolution processing on the matrix data using the weight coefficient matrix, and the data after vector decomposition and convolution processing.

This achieves a data processing method having the same advantageous effects as the data processing apparatus of the first aspect of the present invention.

A ninth aspect of the present invention provides a non-transitory computer readable storage medium storing a program for causing a computer to execute the data processing method of the eighth aspect of the present invention.

This achieves a non-transitory computer readable storage medium storing a program for causing a computer to execute the data processing method having the same advantageous effects as the data processing apparatus of the first aspect of the present invention.

What is claimed is:

1. A data processing apparatus for performing convolution processing on matrix data including a plurality of elements using a weight coefficient matrix, comprising:
vector decomposition processing circuitry that performs vector decomposition processing of decomposing the weight coefficient matrix into a basis matrix whose elements are basis values and a real number coefficient vector whose elements are real numbers;
quantization processing circuitry that is capable of performing multiple types of data adjustment processing, selects one of the multiple types of data adjustment processing, performs the selected data adjustment processing on the matrix data to obtain data after data adjustment processing, and performs quantization processing on the obtained data after data adjustment processing to obtain data after quantization processing;
convolution processing circuitry that performs convolution processing on the data after quantization processing using the basis matrix and the real number coefficient vector that have been obtained in the vector decomposition by the vector decomposition processing circuitry, thereby obtaining data after convolution processing as data after vector decomposition and convolution processing; and
evaluation circuitry that obtains an evaluation result based on a correct matrix data, which is data obtained by convolution processing on the matrix data using the weight coefficient matrix, and the data after vector decomposition and convolution processing.

2. The data processing apparatus according to claim 1,
wherein the vector decomposition processing circuitry initializes the basis matrix using first random numbers and initializes the real number coefficient vector using second random numbers, repeatedly updates the basis matrix and/or the real number coefficient vector so that a matrix obtained by a product of the initialized basis matrix and the initialized real number coefficient vector becomes closer to the weight coefficient matrix, and obtains the basis matrix and the real number coefficient vector when an error between the obtained matrix and the weight coefficient matrix has been within a certain range of error as a local solution basis matrix and a local solution real number coefficient vector, and
wherein the convolution processing circuitry performs the convolution processing using the local solution basis matrix and the local solution real number coefficient vector.

3. The data processing apparatus according to claim 2,
wherein the vector decomposition processing circuitry obtains L local solution basis matrixes and L local solution real number coefficient vectors by changing initial settings, L being a natural number equal to or greater than two,
wherein the quantization processing circuitry is capable of performing M types of the data adjustment processing, M being a natural number equal to or greater than two, and performs the M types of the data adjustment processing to obtain M pieces of data after quantization processing,
wherein the convolution processing circuitry performs convolution processing on the M pieces data after quantization processing obtained by the quantization processing circuitry using each set of the L local solution basis matrixes and the L local solution real number coefficient vectors, and
wherein the evaluation circuitry obtains, as the evaluation result, comparison result between the correct matrix data and each data obtained by performing convolution processing on the M pieces of data after quantization processing using each set of the L local solution basis matrixes and the L local solution real number coefficient vectors, determines a combination of the local solution basis matrix and the local solution real number coefficient vector and the type of the data adjustment processing when the comparison result is optimal, and obtains data of the determined combination as optimal solution data of vector decomposition processing and data adjustment processing.

4. The data processing apparatus according to claim 1,
wherein the multiple types of data adjustment processing includes one of:
(1) processing that performs normalization on input data using a maximum value and a minimum value for data distribution of values of elements of matrix data to obtain an output value,
(2) processing that performs standardization on input data using an average value and a standard deviation for data distribution of values of elements of matrix data to obtain an output value, and
(3) processing that performs data range adjustment processing on input data based on a first quartile and a third quartile for data distribution of values of elements of matrix data to obtain an output value.

5. The data processing apparatus according to claim 3,
wherein the vector decomposition processing sequentially obtains L local solution basis matrixes and L local solution real number coefficient vectors by changing initial settings, L being a natural number equal to or greater than two, obtains a norm of a difference between the weight coefficient matrix and a product of a local solution basis matrix and a local solution real number coefficient vector that have been obtained by the L′-th vector decomposition processing, L′ being a natural number satisfying L′<L, and does not perform the subsequent vector decomposition processing after the L′-th vector decomposition processing when the obtained norm is less than a predetermined threshold, and
wherein when the vector decomposition processing circuitry does not perform the subsequent vector decomposition processing after the L′-th vector decomposition processing, the evaluation circuitry obtains, as the evaluation result, a comparison result of the correct matrix data and each of data obtained by performing convolution processing on the M pieces of data after quantization using each set of the L′ local solution basis matrixes and the L′ local solution real number coefficient vectors, determines a combination of the local solution basis matrix and the local solution real number coefficient vector and the type of the data adjustment processing when the comparison result is optimal, and obtains data of the determined combination as optimal solution data of vector decomposition processing and data adjustment processing.

6. The data processing apparatus according to claim 3, wherein assuming that when each of the M types of the data adjustment processing is performed on N pieces of data as input data, N being a natural number, i-th input data in performing j-th data adjustment processing of the M types of the data adjustment processing is X₀⁽ⁱ⁾(j) and correct data is X₁⁽ⁱ⁾, j being an natural number satisfying 1≤j≤M, i being an natural number satisfying 1≤i≤N, and q-th data that is obtained by multiplying one of the L local solution basis matrixes with its corresponding one of the L local solution real number coefficient vectors is W₀′(q), q being a natural number satisfying 1≤q≤L, the evaluation circuitry performs processing according to the following formula to determine jₒₚₜ and qₒₚₜ, and then obtains data of a combination of the qₒₚₜ-th local solution basis matrix and the qₒₚₜ-th local solution real number coefficient vector and the jₒₚₜ-th data adjustment processing as optimal solution data of vector decomposition processing and data adjustment processing.
$${j}_{opt} , {q}_{opt} = {argmin}_{j , q} Ave\_diff ( N , j , q )$$
$$Ave\_diff ( N , j , q ) = \frac{1}{N} {\sum }_{i = 1}^{N} ‖ {X}_{1}^{( i )} - {W}_{0}^{′} ( q ) * Q ( {X}_{0}^{( i )} ( j ) ) ‖$$
$$1 \leq j \leq M , 1 \leq q \leq L$$

7. A convolution processing apparatus comprising:
quantization processing circuitry that after performing data adjustment processing determined by the optimal solution data obtained by the data processing apparatus according to claim 3 on matrix data including a plurality of elements, performs quantization processing to obtain data after quantization processing; and
convolution processing circuitry that performs convolution processing on the data after quantization processing obtained by the quantization processing circuitry using the local solution basis matrix and the local solution real number coefficient vector that are determined by the optimal solution data.

8. A data processing method for performing convolution processing on matrix data including a plurality of elements using a weight coefficient matrix, comprising:
(a) performing vector decomposition processing of decomposing the weight coefficient matrix into a basis matrix whose elements are basis values and a real number coefficient vector whose elements are real numbers;
(b) being capable of performing multiple types of data adjustment processing, selecting one of the multiple types of data adjustment processing, performing the selected data adjustment processing on the matrix data to obtain data after data adjustment processing, and performing quantization processing on the obtained data after data adjustment processing to obtain data after quantization processing;
(c) performing convolution processing on the data after quantization processing using the basis matrix and the real number coefficient vector that have been obtained in the vector decomposition by the step (a), thereby obtaining data after convolution processing as data after vector decomposition and convolution processing; and
(d) obtaining an evaluation result based on a correct matrix data, which is data obtained by convolution processing on the matrix data using the weight coefficient matrix, and the data after vector decomposition and convolution processing.

9. A non-transitory computer readable storage medium storing a program for causing a computer to execute the data processing method according to claim 8.
